(19) United States
(12) Patent Application Publication
(10) Pub. No.: US 2020/0164667 A1
(43) Pub. Date: May 28, 2020

(54) PRINTER WITH CUTTING HEAD

(71) Applicant: Roland DG Corporation, Hamamatsu-shi (JP)

(72) Inventors: Kenji MATSUSHIME, Hamamatsu-shi (JP); Nobuyoshi SUZUKI, Hamamatsu-shi (JP); Tamakazu KITAMURA, Hamamatsu-shi (JP)

(21) Appl. No.: 16/686,289

(22) Filed: Nov. 18, 2019

(30) Foreign Application Priority Data
Nov. 22, 2018 (JP) 2018-219521

(51) Int. Cl. B41J 11/66; B41J 11/00

(52) U.S. Cl. CPC B41J 11/663; B41J 11/002

(57) ABSTRACT

A printer with a cutting head operates such that a medium is pulled out from a roll until at least a cutting area is moved along a conveying path of the medium to be located farther in a first conveying direction than the cutting head. The first conveying direction is a direction in which the medium is pulled out from the roll. Thereafter, the printer with a cutting head performs cutting while conveying the medium in a second conveying direction in which the medium that has been pulled out is moved back. Thereafter, the printer with a cutting head further performs printing while conveying the medium in the first conveying direction.

### CROSS REFERENCE TO RELATED APPLICATIONS

This application claims the benefit of priority to Japanese Patent Application No. 2018-219521 filed on Nov. 22, 2018. The entire contents of this application are hereby incorporated herein by reference.

### BACKGROUND OF THE INVENTION

### 1. Field of the Invention

The present invention relates to a printer with a cutting head.

### 2. Description of the Related Art

Conventionally, printers with a cutting head, which print an image on a medium and cut the medium, have been known. For example, Japanese Laid-open Patent Publication No. 2018-12163 discloses a printer with a cutting head, which includes a print head, a cutting head, and a crop mark detector. Crop marks are reference marks that are position references used in cutting. The crop marks are printed on a medium during printing before cutting.

For example, Japanese Laid-open Patent Publication No. 2013-159079 discloses a printer with a cutting head, configured to perform cutting before printing. An object of the printer with a cutting head described in Japanese Laid-open Patent Publication No. 2013-159079 is to reduce a waiting time for waiting for drying ink. In order to achieve the object, the printer with a cutting head described in Japanese Laid-open Patent Publication No. 2013-159079 first prints crop marks on a medium and, after alignment for cutting is performed based on the crop marks, performs cutting. Then, after cutting, an image is printed. In the printer with a cutting head disclosed in Japanese Laid-open Patent Publication No. 2013-159079, printing is performed after cutting, and therefore, a time for waiting for drying ink is not needed.

In a method disclosed in Japanese Laid-open Patent Publication No. 2013-159079, firstly a medium is reciprocatively moved once in a step of printing crop marks only, then secondly the medium is reciprocatively moved once in cutting, and finally is moved one way in printing an image, that is, the medium is reciprocatively moved 2.5 times in total, in a conveying direction. Furthermore, although not described in Japanese Laid-open Patent Publication No. 2013-159079, in a case in which the medium is provided from a roll, it is actually necessary to pull out the medium from the roll before printing in order to peel off the medium from the roll, and thereafter, reciprocatively move the medium once to move back the medium to a print start position. Therefore, in the case in which the medium is supplied from the roll, in the method described in Japanese Laid-open Patent Publication No. 2013-159079, the medium is reciprocatively moved in the conveying direction 3.5 times in total. On the other hand, in a typical method in which printing is performed first and cutting is performed thereafter, as for conveyance of a medium, the medium is reciprocatively moved once in a step of moving back the medium to a print start position after pulling out the medium from a roll, is reciprocatively moved once in printing an image and crop marks, and is moved one way in cutting, that is, the medium is reciprocatively moved 2.5 times in total. As described above, in the method described in Japanese Laid-open Patent Publication No. 2013-159079, a time for waiting for drying ink after printing is not needed, but a time required for conveying the medium is increased. Accordingly, productivity cannot be increased by the method disclosed in Japanese Laid-open Patent Publication No. 2013-159079 in some cases. However, when printing of crop marks is merely omitted in order to increase productivity, there is a probability that a positional relation between a cut line for cutting and a printed image is shifted.

### SUMMARY OF THE INVENTION

In view of the foregoing, preferred embodiments of the present invention provide printers each including a cutting head and using a roll medium and reduces or prevents a shift of a positional relation between a printed image and a cut line while increasing productivity.

A printer with a cutting head disclosed herein includes a holder to rotatably hold a roll into which a medium is wound, a conveyer to convey the medium, a cutting head, a cutting head mover to move the cutting head, a print head, and a controller. The conveyer conveys the medium in a first conveying direction in which the medium is pulled out from the roll and in a second conveying direction in which the medium that has been pulled out is moved back toward the roll. The cutting head mover moves the cutting head such that the cutting head crosses a conveying path of the medium. The print head performs printing on the medium which is on the conveying path. The controller includes a data storage, a first processor, a second processor, a cutting controller, and a print controller. The data storage saves cutting data and print data. The first processor is configured or programmed to determine, based on the cutting data saved in the data storage, a cutting area on the medium in which the cutting head performs cutting. The second processor controls the conveyer to pull out the medium from the roll until at least the cutting area is moved along the conveying path of the medium to be located farther in the first conveying direction than the cutting head. The cutting controller controls, after the medium has been pulled out by the second processor, the cutting head mover, the cutting head, and the conveyer to perform cutting while conveying the medium in the second conveying direction. The print controller controls, after cutting has been performed on the medium by the cutting controller, the print head and the conveyer to perform printing while conveying the medium in the first conveying direction.

The above described printer performs, after pulling out the medium from the roll once, cutting while pulling back the medium toward the roll. After cutting, the printer performs printing while conveying the medium in a direction in which the medium is pulled out from the roll. According to this configuration, printing is performed after cutting, and therefore, a time for waiting for drying ink is not needed. In the above described printer, the number of times the medium is reciprocatively moved is 1.5, for example, and a time for conveying the medium is able to be reduced. Accordingly, productivity is able to be increased.

According to the discoveries of the present inventor, a shift between a print position and a cutting position occurs mainly because of expansion and contraction of a medium caused by printing, accumulation of position shifts caused by slips that occur during conveyance of the medium, or the like. In the above described printer with a cutting head, cutting is performed on a medium on which crop marks are not printed. Thus, at the time of cutting, expansion and contraction caused by printing crop marks do not occur in the medium. In the above described printer with a cutting head, the minimum number of times the medium is reciprocatively moved is 1.5, for example, and accumulation of position shifts caused by slips of the medium during conveyance of the medium is small. Therefore, according to the above described printer, a shift of a positional relation between a printed image and a cut line is able to be reduced or prevented.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a printer with a cutting head according to a preferred embodiment of the present invention.

FIG. 2 is a schematic left side view of a main portion of the printer with a cutting head.

FIG. 3A is a front view of a print head and a cutting head in a state in which a first carriage and a second carriage are connected to each other.

FIG. 3B is a front view of the print head and the cutting head in a state in which the first carriage and the second carriage are separated from each other.

FIG. 4 is a block diagram of the printer with a cutting head.

FIG. 5 is a flowchart illustrating steps of printing and cutting by a first known method.

FIG. 6 is a plan view illustrating a medium on which printing and cutting have been performed by the first known method.

FIG. 7 is a flowchart illustrating steps of printing and cutting by a second known method.

FIG. 8 is a flowchart illustrating steps of printing and cutting.

FIG. 9 is a plan view illustrating a medium on which cutting has been performed by the printer with a cutting head.

FIG. 10 is a plan view illustrating the medium on which cutting and printing have been performed by the printer with a cutting head.

FIG. 11 is a front view illustrating a configuration of a first carriage in a case in which ink is photo curable ink.

### DETAILED DESCRIPTION OF THE PREFERRED EMBODIMENTS

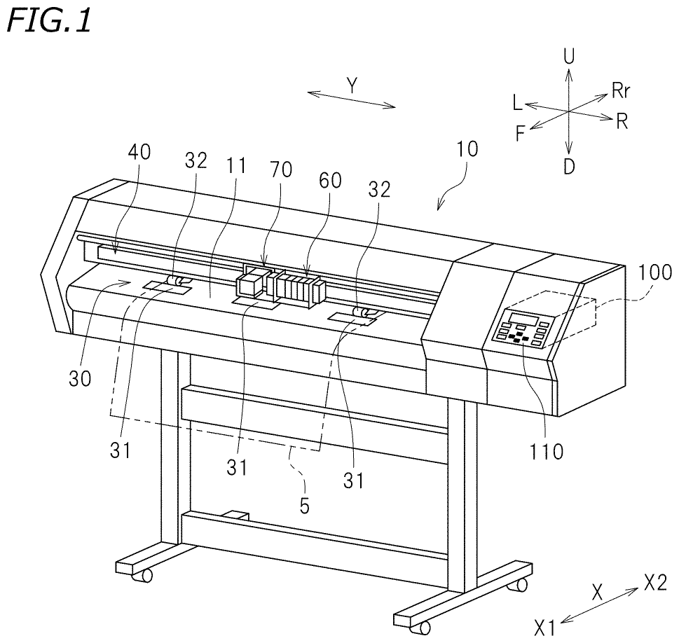

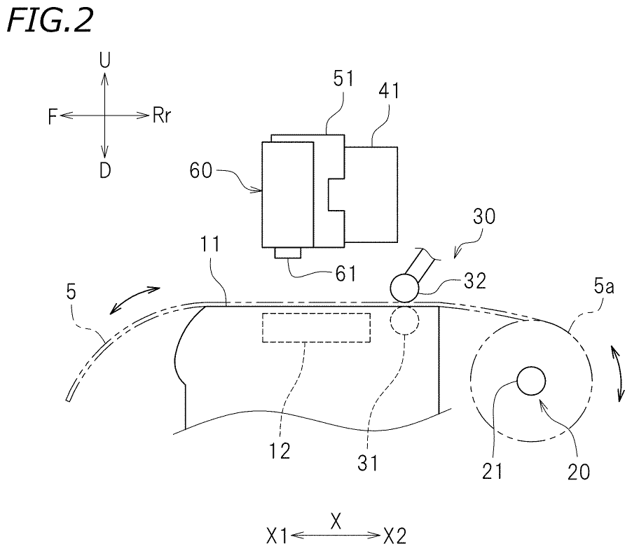

With reference to the attached drawings, preferred embodiments of the present invention will be described below. FIG. 1 is a perspective view of an ink jet printer 10 (which will be hereinafter referred to as a printer 10) with a cutting head according to a preferred embodiment of the present invention. FIG. 2 is a schematic left side view of a main portion of the printer 10. As illustrated in FIG. 1, the printer 10 according to this preferred embodiment performs printing and cutting on a medium 5. Although not illustrated, the medium 5 according to this preferred embodiment is a seal material including a mount and a release paper which is stacked on the mount and to which an adhesive is applied. However, the medium 5 may be any medium on which printing and cutting can be performed, and there is no particular limitation on the medium 5. The medium 5 may be a sheet of recording paper, a resin sheet, or the like. As illustrated in FIG. 2, the medium 5 is wound to form a roll 5a. The printer 10 according to this preferred embodiment performs printing and cutting on the medium 5 while sequentially pulling out the medium 5 supplied as the roll 5a. As used herein “cutting” includes a case in which the medium 5 is entirely cut off in a thickness direction (for example, a case in which both of the mount and the release paper of the seal material are cut off) and a case in which the medium 5 is partially cut off in the thickness direction (for example, a case in which the mount of the seal material is not cut off and only the releases paper is cut off).

The printer 10 includes a medium supplier 20 that supplies the medium 5, a platen 11 that supports a portion of the medium 5 which has been pulled out from the roll 5a, a conveyor 30 that conveys the medium 5, a heater 12 that heats the medium 5, a print head 60 that performs printing on the medium 5, a cutting head 70 that cuts off the medium 5, and a head mover 40 that moves the print head 60 and the cutting head 70. Although details will be described later, the print head 60 and the cutting head 70 are movable in a Y direction illustrated in the drawings. The medium 5 is able to be conveyed in an X direction illustrated in the drawings. The Y direction will be hereinafter referred to as a scanning direction and the X direction will be hereinafter referred to as a conveying direction as appropriate. The scanning direction Y is a left-right direction herein. The conveying direction X is a front-rear direction herein. In the conveying direction X, one direction will be hereinafter referred to as a first conveying direction X1 and the other direction will be hereinafter referred to as a second conveying direction X2. The first conveying direction X1 is directed to a front of the printer 10 herein. The second conveying direction X2 is directed to a rear of the printer 10 herein. Note that the scanning direction Y corresponds to a width direction of the medium 5, and the conveying direction X corresponds to a longitudinal direction (a winding direction) of the medium 5. The reference symbols F, Rr, L, R, U, and D in FIG. 1 indicate front, rear, left, right, up, and down, respectively.

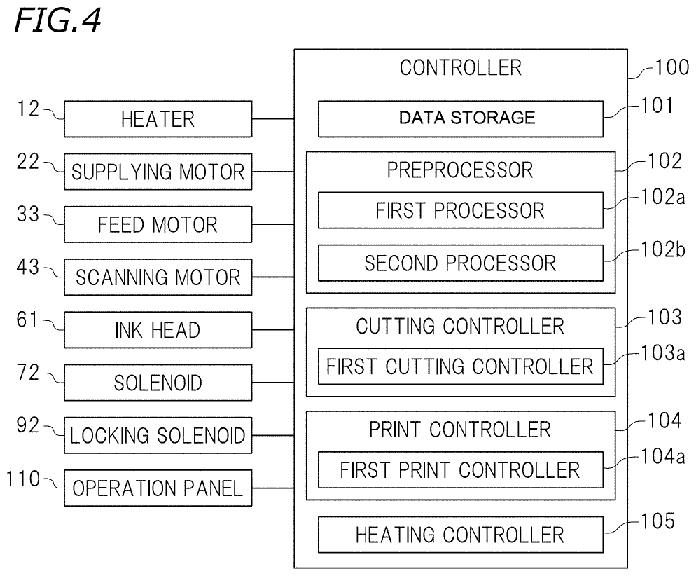

As illustrated in FIG. 2, the medium supplier 20 is disposed diagonally behind below the platen 11. The medium supplier 20 supplies the medium 5 onto the platen 11. The medium supplier 20 includes a supplying roll 21 and a supplying motor 22 (see FIG. 4). The supplying roll 21 rotatably holds the roll 5a into which the medium 5 is wound. The supplying roll 21 preferably has a cylindrical shape. The supplying roll 21 extends in the scanning direction Y. The supplying roll 21 is rotatable around a center axis that extends in the scanning direction Y. The roll 5a of the medium 5 is attached to an outer peripheral portion of the supplying roll 21. Accordingly, when the supplying roll 21 rotates, the roll 5a also rotates in the same direction. The medium 5 is pulled out from the roll 5a toward the front (in the first conveying direction X1).

The supplying motor 22 causes the supplying roll 21 to rotate. When the supplying motor 22 is driven, the supplying roll 21 rotate accordingly. The supplying motor 22 is electrically connected to a controller 100 and is controlled by the controller 100. However, the medium supplier 20 may not include the supplying motor 22 that causes the supplying roll 21 to rotate, and the supplying roll 21 may merely rotate following the medium 5 as the medium 5 is pulled out. The supplying roll 21 may not rotate and instead may merely rotatably support the roll 5a. There is no particular limitation on a configuration of the medium supplier 20.

The conveyor 30 moves the medium 5 in the conveying direction X. The conveyor 30 includes grit rollers 31, pinch rollers 32, and a feed motor 33 (see FIG. 4). The grit rollers 31 are provided in the platen 11. The grit rollers 31 are driven by the feed motor 33 and rotate. The pinch rollers 32 are disposed over the grit rollers 31. The pinch rollers 32 are opposed to the grit rollers 31. The pinch rollers 32 are vertically slidable so as to be able to move close to and apart from the grit rollers 31. When the grit rollers 31 rotate in a state in which the medium 5 is sandwiched between the pinch rollers 32 and the grit rollers 31, the medium 5 is conveyed in the first conveying direction X1 (forward) or in the second conveying direction X2 (rearward). As illustrated in FIG. 2, a conveying path of the medium 5 is set on a route extending from the roll 5a to the platen 11 and on the platen 11. The feed motor 33 is electrically connected to the controller 100 and is controlled by the controller 100.

The first conveying direction X1 is a direction in which the medium 5 is pulled out from the roll 5a. The second conveying direction X2 is a direction in which the medium 5 that has been pulled out is moved back toward the roll 5a. The second conveying direction X2 is an opposite direction to the first conveying direction X1. The conveyor 30 moves the medium 5 in the conveying direction X by pinching a portion of the medium 5, which has been pulled out from the roll 5a, by the grit rollers 31 and the pinch rollers 32. The conveyor 30 moves the medium 5 in the first conveying direction X1 and the second conveying direction X2. Note that, although only three grit rollers 31 and two pinch rollers 32 are illustrated in FIG. 1, more grit rollers 31 and pinch rollers 32 may be provided such that the grit rollers 31 are arranged in a line and the pinch rollers 32 are arranged in a line in the scanning direction Y in an actual situation.

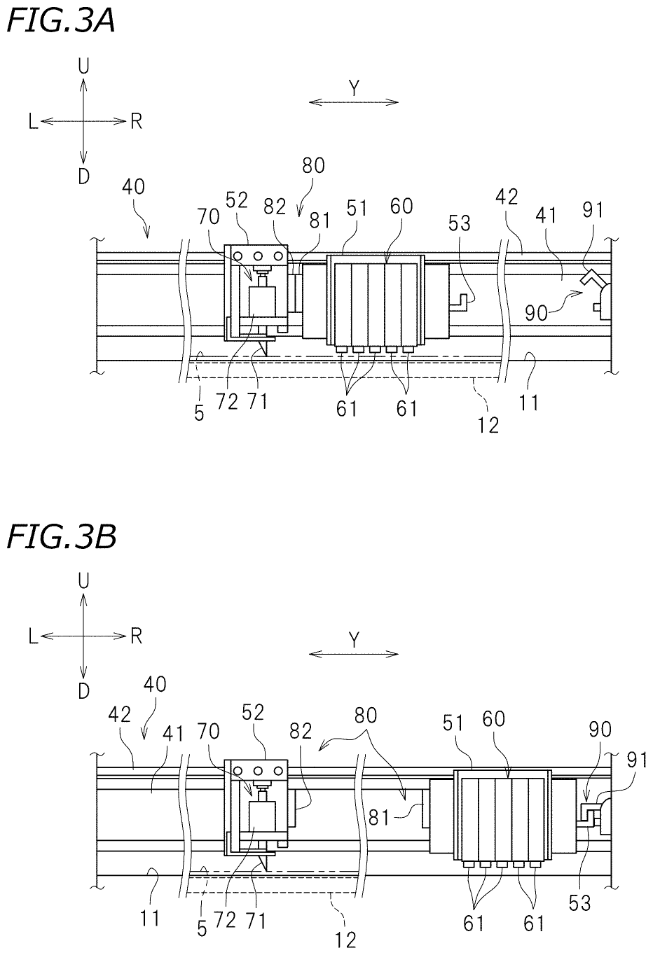

The head mover 40 moves the print head 60 and the cutting head 70 in the scanning direction Y. FIG. 3A and FIG. 3B are front views of the print head 60 and the cutting head 70. FIG. 3A illustrates a state in which a first carriage 51 on which the print head 60 is mounted and a second carriage 52 on which the cutting head 70 is mounted are connected to each other. FIG. 3B illustrates a state in which the first carriage 51 and the second carriage 52 are separated from each other. In the state in which the first carriage 51 and the second carriage 52 are connected to each other, the head mover 40 moves the first carriage 51 and the second carriage 52 as one unit. In the state in which the first carriage 51 and the second carriage 52 are separated from each other, the head mover 40 moves only the second carriage 52 alone.

As illustrated in FIG. 3A and FIG. 3B, the head mover 40 includes a guide rail 41, a belt 42, and a scanning motor 43 (see FIG. 4). The guide rail 41 is provided over the platen 11. The guide rail 41 is disposed farther in the first conveying direction X1 than the supplying roll 21. The guide rail 41 extends in the scanning direction Y. The first carriage 51 and the second carriage 52 are slidably engaged with the guide rail 41. The print head 60 is mounted on the first carriage 51. The cutting head 70 is mounted on the second carriage 52. The print head 60 and the cutting head 70 are engaged with the guide rail 41 via the first carriage 51 and the second carriage 52, respectively. The second carriage 52 is engaged with the guide rail 41 on a left side of the first carriage 51.

The belt 42 extends in the scanning direction Y. The belt 42 is fixed to an upper portion of a back surface of the second carriage 52. The belt 42 is connected to the scanning motor 43. When the scanning motor 43 rotates, the belt 42 runs in the scanning direction Y. Thus, the second carriage 52 moves in the scanning direction Y. The scanning motor 43 is electrically connected to the controller 100 and is controlled by the controller 100.

The first carriage 51 and the second carriage 52 are connected to each other or are separated from one another by a connector 80. As illustrated in FIG. 3A and FIG. 3B, the connector 80 includes a first connector 81 provided in the first carriage 51 and a second connector 82 provided in the second carriage 52. The first connector 81 is provided on a left side portion of the first carriage 51. The second connector 82 is provided on a right side portion of the second carriage 52. In this preferred embodiment, the connector 80 connects the first carriage 51 and the second carriage 52 using magnetic force. One of the first connector 81 and the second connector 82 includes a magnet and the other one of the first connector 81 and the second connector 82 includes a magnetic body that attracts the magnet. However, the connector 80 is not limited to a connector using magnetic force and may have some other configuration, such as an engaging member or the like. The first connector 81 and the second connector 82 contact each other, and thus, the first carriage 51 and the second carriage 52 are connected to each other.

A receiving metal fitting 53 that preferably is preferably L-shaped or substantially L-shaped is provided on a right side of the first carriage 51. A lock 90 used to fix the first carriage 51 is provided around a right end of the guide rail 41. A position of the right end of the guide rail 41 to which the first carriage 51 is fixed will be hereinafter referred to as a standby position. The lock 90 includes a hook 91 that is hooked on the receiving metal fitting 53 and a locking solenoid 92 (see FIG. 4) that moves the hook 91 between a lock position (see FIG. 3B) and an unlock position (see FIG. 3A). The locking solenoid 92 is electrically connected to the controller 100 and is controlled by the controller 100.

As illustrated in FIG. 3A, when printing by the print head 60 is performed, the hook 91 is set to the unlock position. When the second carriage 52 moves rightward and the first connector 81 and the second connector 82 contact with each other, the second carriage 52 and the first carriage 51 are connected to each other. As a result, the first carriage 51 is movable with the second carriage 52 in the scanning direction Y. The print head 60 and the cutting head 70 are moved in the scanning direction Y so as to cross a moving path of the medium 5 (on the platen 11 herein).

On the other hand, in performing cutting by the cutting head 70, as illustrated in FIG. 3B, the first carriage 51 is positioned in the standby position, and the hook 91 of the lock 90 is set to the lock position. Thus, movement of the first carriage 51 is blocked. When the second carriage 52 moves leftward, the first connector 81 and the second connector 82 are separated from each other and connection of the second carriage 52 and the first carriage 51 is removed. As a result, in a state in which the first carriage 51 stands by in the standby position, the second carriage is movable in the scanning direction Y. At this time, the cutting head 70 is moved alone in the scanning direction Y on the moving path of the medium 5 (on the platen 11 herein).

The print head 60 is mounted on the first carriage 51. The print head 60 includes a plurality of ink heads 61. The print head 60 includes five ink heads 61 herein, for example. The plurality of ink heads 61 are disposed in a line in the scanning direction Y. A plurality of nozzles (not illustrated) are provided on lower surfaces of the plurality of ink heads 61. Each of the plurality of nozzles ejects ink. The plurality of nozzles are disposed in a line in the conveying direction X. The five ink heads 61 eject inks of five different colors, for example, yellow ink, magenta ink, cyan ink, black ink, and white ink. However, the number of the ink heads 61 is not limited to five, and there is no limitation on colors of the inks ejected by the ink heads 61.

In this preferred embodiment, thermosetting ink is used. The thermosetting ink is, for example, solvent ink or the like, and is dried and cured by heat. The print head 60 ejects the thermosetting ink to the medium 5 on the platen 11. The print head 60 performs printing on the medium 5 by ejecting the thermosetting ink.

The ink heads 61 are, for example, ink jet heads. However, a printing system of the print head 60 is not limited to an ink jet system, and the print head 60 is not limited to a print head including an ink jet head. The print head 60 may include a print head that performs, for example, printing of a dot impact system.

The cutting head 70 is mounted on the second carriage 52. The cutting head 70 includes a cutter 71 and a solenoid 72. The cutter 71 is able to move in an up-down direction by the solenoid 72. When the solenoid 72 is turned on and off, the cutter 71 moves in the up-down direction to contact the medium 5 or be separated from the medium 5. The solenoid 72 is electrically connected to the controller 100 and is controlled by the controller 100.

In this preferred embodiment, the head mover 40 moves the cutting head 70 alone or the print head 60 and the cutting head 70 as one unit in the scanning direction Y. However, a configuration of the head mover is not limited to the above described configuration. The head mover may have a function as a cutting head mover that moves the cutting head 70 such that the cutting head 70 crosses the conveying path of the medium 5, and there is no other limitation thereon. For example, the print head may be a so-called line head, and may not move. The print head may perform printing on the medium 5 placed on the conveying path. Even in a case in which both of the print head 60 and the cutting head 70 move, the head mover may be divided into a first mover that moves the print head 60 in the scanning direction Y and a second mover that moves the cutting head 70 in the scanning direction Y. For example, the print head 60 and the cutting head 70 may be engaged with different guide rails and may be moved by different driving units.

The heater 12 is provided under the platen 11. The heater 12 is able to contact a lower surface of the platen 11. The heater 12 includes, for example, a heating wire or the like. The heater 12 indirectly heats the medium 5 by heating the platen 11. However, the heater 12 may heat the medium 5, for example, by blowing a hot air to the medium 5. There is no particular limitation on a system of the heater 12. The heater 12 is provided on a back side of the platen 11 herein. The heater 12 is provided immediately under the print head 60, in a portion therearound, and behind the print head 60 in the scanning direction Y.

As illustrated in FIG. 1, an operation panel 110 including a button and a display is disposed on a front surface of a side cover at right side of the printer 10. The operation panel 110 is connected to the controller 100. FIG. 4 is a block diagram of the printer 10. As illustrated in FIG. 4, the controller 100 is connected to the heater 12, the supplying motor 22, the feed motor 33, the scanning motor 43, the ink heads 61, the solenoid 72, the locking solenoid 92, and the operation panel 110 and controls operation of the components.

There is no particular limitation on a configuration of the controller 100. The controller 100 is, for example, a microcomputer. There is no particular limitation on a hardware configuration of the microcomputer. The microcomputer includes, for example, an interface (I/F) to receive print data, cutting data, or the like from an external device, such as a host computer or the like, a central processing unit (CPU) configured or programmed to execute an order of a control program, a read-only memory (ROM) to store a program that is executed by the CPU, a random access memory (RAM) used as a working area in which the program is developed, and a storage, such as a memory or the like, to store the above described program and various types of data. Note that the controller 100 may not be provided inside the printer 10, and may be, for example, a computer or the like which is installed outside the printer 10 and is communicably connected with the printer 10 via a wired or wireless communication.

As illustrated in FIG. 4, the controller 100 includes a data storage 101, a preprocessor 102, a cutting controller 103, a print controller 104, and a heating controller 105. The controller 100 may include some other processor or processors, but illustration and description thereof will be omitted herein.

The data storage 101 saves cutting data and print data. Work data including the cutting data and the print data is created by an external computer or the like and is transmitted to the controller 100. The data storage 101 temporarily saves the work data. The cutting controller 103 and the print controller 104 execute contents of the work data temporarily saved in the data storage 101.

The preprocessor 102 controls an operation of pulling out the medium 5 from the roll 5a before cutting and printing. Although details will be described later, in this preferred embodiment, the medium 5 is pulled out in the first conveying direction X1 (forward herein) once before cutting and printing. The preprocessor 102 includes a first processor 102a and a second processor 102b. The first processor 102a determines an area (which will be hereinafter referred to as a cutting area) on the medium in which the cutting head 70 performs cutting, based on the cutting data saved in the data storage 101. The second processor 102b controls the conveyor 30 to pull out the medium 5 from the roll 5a until at least the cutting area moves along the conveying path of the medium 5 to be located farther in the first conveying direction X1 than the cutting head 70. In this preferred embodiment, the second processor 102b is set to convey the medium 5 in the first conveying direction X1 until a rear end of the cutting area reaches directly under the cutting head 70.

The cutting controller 103 performs control related to cutting. The cutting controller 103 according to this preferred embodiment is set to control, after the medium 5 has been pulled out from the roll 5a by the second processor 102b, the head mover 40, the cutting head 70, and the conveyor 30 to perform cutting while conveying the medium 5 in the second conveying direction X2. In this preferred embodiment, cutting is performed while moving back the medium 5 toward the roll 5a.

The cutting controller 103 includes a first cutting controller 103a. The first cutting controller 103a is set to perform, after the medium 5 has been pulled out from the roll 5a by the second processor 102b, cutting without correcting a cutting position. More specifically, it is also set to start cutting without printing crop marks that are references for the cutting position on the medium 5 and performing position correction using the crop marks. Details of this control will be described later.

The print controller 104 performs control related to printing. The print controller 104 according to this preferred embodiment is set to control, after cutting has been performed on the medium 5 by the cutting controller 103, the head mover 40, the print head 60, and the conveyor 30 to perform printing while conveying the medium 5 in the first conveying direction X1. In this preferred embodiment, after cutting is terminated, printing is performed while moving the medium 5 in the first conveying direction X1.

The print controller 104 includes a first print controller 104a. The first print controller 104a is set to perform, after cutting has been performed on the medium 5 by the cutting controller 103, printing without correcting a print position. More specifically, it is also set to start cutting without performing position correction using the crop marks. Details of this control will be also described later.

The heating controller 105 controls an operation of the heater 12. The heating controller 105 is set to stop the heater 12 during cutting and operate the heater 12 during printing. Note that, in this preferred embodiment, the heater 12 is not provided farther in the first conveying direction X1 than the print head 60 and does not heat the medium 5 after printing, but the heater 12 may heat the medium 5 also after printing. As another option, the heater 12 may heat the medium 5 only after printing. The heating controller 105 may operate the heater 12 at least one of during printing and after printing. A condition of heating by the heater 12 may be appropriately set in accordance with drying property of ink or the like.

An operation of the printer 10 according to this preferred embodiment will be described below as comparing the operation with known printing and cutting methods, as appropriate. In the following description, a known method (a first method) will be described first. In the first method, a printer with a cutting head is operative such that a medium is supplied in a form of a roll and cutting is performed after printing. A known method (a second known method) will be described next. In the second method, a printer with a cutting head is operative such that a medium is supplied in a form of a roll and printing is performed after cutting. Note that each of the known printers with a cutting head may have a similar mechanical configuration to that of this preferred embodiment except that each of the known printers includes a crop mark detector. Therefore, in the following description of the known methods, components in common with those in this preferred embodiment are denoted by the same reference symbols used in the description of this preferred embodiment. Each of the first and second known methods is merely an example.

First Known Method

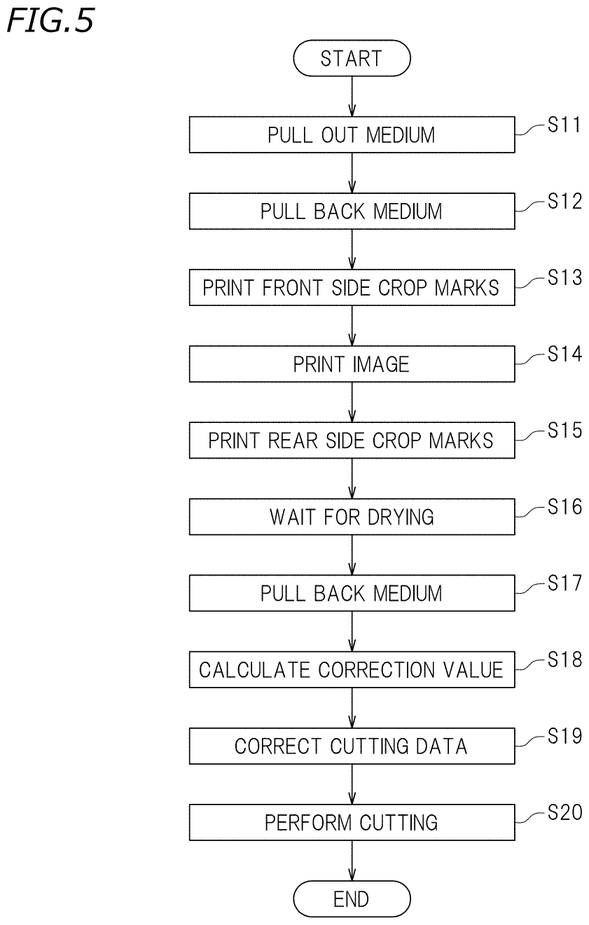

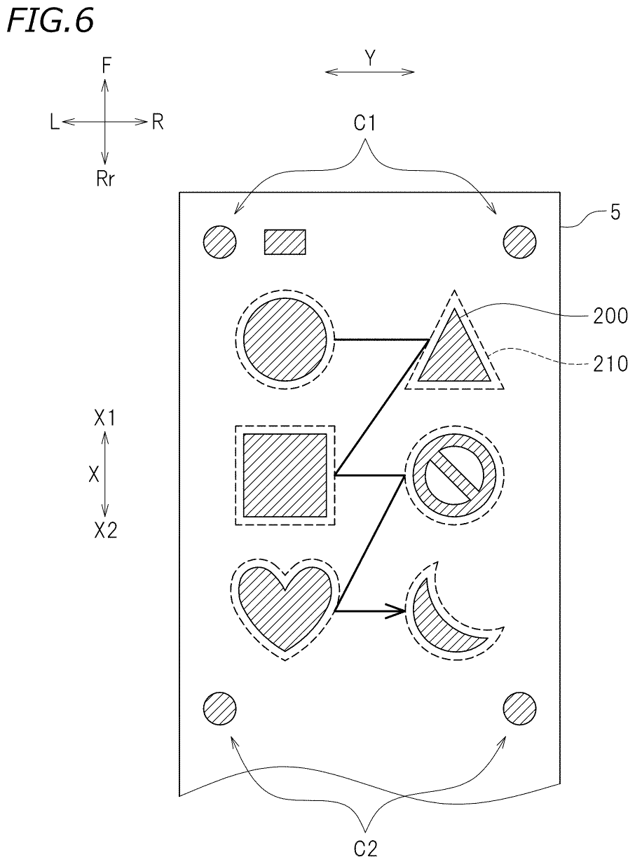

The first known method is an example of a printing and cutting method in which printing is performed first and cutting is performed after printing. FIG. 5 is a flowchart illustrating steps of printing and cutting by the first known method. FIG. 6 is a plan view illustrating the medium 5 on which printing and cutting have been performed by the first known method. As illustrated in FIG. 5, in this preferred embodiment, Step S11 to S20 are executed.

In Step S11, the medium 5 is pulled out in the first conveying direction X1. In some cases, the medium 5 is already sandwiched between the grit rollers 31 and the pinch rollers 32 by printing and cutting performed before Step S11. As another option, the medium 5 may be sandwiched by the grit rollers 31 and the pinch rollers 32 again in this step. In Step S11, the grit rollers 31 are caused to rotate in a state in which the medium 5 is sandwiched by the grit rollers 31 and the pinch rollers 32. Thus, the medium 5 is moved in the first conveying direction X1. In subsequent Step S12, the medium 5 is moved in the second conveying direction X2 by the grit rollers 31 and the pinch rollers 32. In Step S12, the medium 5 is pulled back to a print start position.

The medium 5 is peeled off from the roll 5a once by Step S11 described above. After this, the medium 5 is conveyed in the conveying direction X without impairing position accuracy due to adhesion between the medium 5 and the roll 5a. The medium 5 is moved back to the print start position in Step S12 in order to perform printing in Step S13 and subsequent steps. The medium 5 has been reciprocatively moved in the moving conveying direction X once by Steps S11 and S12.

In Step S13 to S15, printing of an image 200 and crop marks C1 and C2 is performed. In Step S13, the front side crop marks C1 are printed. In Step S13, first, the first carriage 51 and the second carriage 52 are connected to each other. Thus, the print head 60 can be moved by the head mover 40. In printing, the print head 60 is moved with the first carriage 51 in the scanning direction Y and ejects ink. Thus, printing in one position in the conveying direction X is completed. Thereafter, the medium 5 is conveyed in the first conveying direction X1. Next printing is performed in a position in the conveying direction X after the above described movement. By repeating this operation, the front side crop marks C1 are printed on the medium 5.

In Step S14, the image 200 is printed on the medium 5. In subsequent Step S15, the rear side crop marks C2 are printed on the medium 5.

In Step S13 to S15, the medium 5 is heated by the heater 12. An area of the platen 11 behind the print head 60 is heated by the heater 12. Accordingly, each portion of the medium 5 is heated before and during printing.

Step S16 is a step of waiting for drying ink. In Step S16, a time for waiting for drying ink occurs.

In Step S17, the medium 5 is pulled back again to the printing start position in the second conveying direction X2. The medium 5 is further reciprocatively moved once in the conveying direction X by Steps S13 to S17.

In Step S18, positions of the crop marks C1 and C2 are detected by a crop mark detector, and a correction value for the cutting position is calculated. In Step S19, cutting data is corrected based on the above described correction value. Various technologies for this correction method have been known, and therefore, description thereof will be omitted. Without correcting the cutting position by Steps S18 and S19, a positional relation between the image 200 and a cut line 210 is likely to be shifted. This shift is caused, for example, by expansion and contraction of the medium 5 during printing, a slip caused between the medium 5 and the grit rollers 31 during conveyance of the medium 5, or the like. Expansion and contraction of the medium 5 are caused, for example, by absorption of ink and heating by the heater 12.

In Step S20, cutting is performed based on the cutting data after being corrected. In Step S20, first, the first carriage 51 and the second carriage 52 are separated from each other. Thus, the cutting head 70 can be moved alone. The cutter 71 is lowered to contact the medium 5. In cutting, the medium 5 is moved in the conveying direction X while moving the cutting head 70 in the scanning direction Y. Thus, a cutting edge of the cutter 71 moves along the cut line 210 on the medium 5. Cutting in Step S20 is basically performed while moving the medium 5 in the first conveying direction X1. In a case illustrated in FIG. 6, cutting is performed in an order indicated by an arrow illustrated in FIG. 6. The medium 5 is moved by an amount corresponding to one way (for example, 0.5 reciprocations) in the conveying direction X by Step S20. Note that, as understood from FIG. 6, “performing cutting while conveying the medium 5 in the first conveying direction X1” includes a case in which, even when the medium 5 is temporarily moved in the second conveying direction X2 that is an opposite direction to the first conveying direction X1, the medium 5 is finally moved in the first conveying direction X1.

As described above, in the first known method in which printing is performed first and cutting is performed after printing, the medium 5 is reciprocatively moved once in Steps S11 and S12, is reciprocatively moved once in Steps S13 to S17, and reciprocatively moved 0.5 times in Step S20, that is, the medium 5 is reciprocatively moved 2.5 times in total, in the conveying direction X. In Step S16, a time for waiting for drying ink occurs. Furthermore, in Steps S13 and S15, a time for printing each of the crop marks C1 and C2 occurs, and in Steps S18 and S19, a time for correcting the cutting position occurs.

In the first known method, it is difficult to increase productivity particularly because there is a step of waiting for drying ink.

Second Known Method

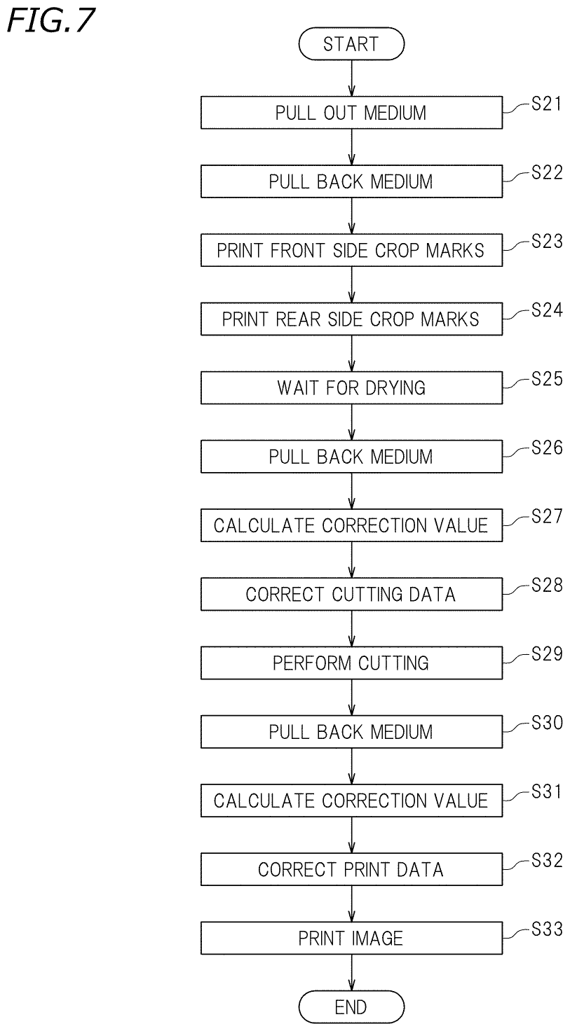

Next, the second known method will be described. The second known method is an example of a printing and cutting method in which cutting is performed first and printing is performed after cutting. FIG. 7 is a flowchart illustrating steps of printing and cutting by the second known method. As illustrated in FIG. 7, in this method, Steps S21 to S33 are executed.

In Steps S21 and S22, similar to Steps S11 and S12 in the first known method, pulling out and pulling back of the medium 5 are executed. The medium 5 is reciprocatively moved once in the conveying direction X by Steps S21 and S22.

In Steps S23 and S24, only the crop marks C1 and C2 are printed on the medium 5. In stages of Steps S23 and S24, the image 200 is not printed. In Step S23, the front side crop marks C1 are printed on the medium 5 while the medium 5 is sent in the first conveying direction X1. In subsequent Step S24, the rear side crop marks C2 are printed on the medium 5 while the medium 5 is subsequently sent in the first conveying direction X1. In Step S25, it is waited for ink forming the crop marks C1 and C2 to dry.

In Step S26, the medium 5 is pulled back to the print start position in the second conveying direction X2. The medium 5 is further reciprocatively moved once in the conveying direction X by Steps S23 to S26.

In Step S27, the positions of the crop marks C1 and C2 are detected by the crop mark detector, and a correction value for the cutting position is calculated. In Step S28, the cutting data is corrected based on the above described correction value.

In Step S29, cutting is performed based on the cutting data after being corrected. Cutting of Step S29 is performed while moving the medium 5 in the first conveying direction X1. In Step S30, the medium 5 is moved back in the second conveying direction X2. The medium 5 is reciprocatively moved three times in total in the conveying direction X by the steps described so far.

In Step S31, the positions of the crop marks C1 and C2 are detected by the crop mark detector, and a correction value for the printing position is calculated. In Step S32, the printing data is corrected based on the above described correction value.

In Step S33, printing is performed based on the printing data after being corrected. Printing of Step S33 is performed while moving the medium 5 in the first conveying direction X1. The medium 5 is reciprocatively moved 3.5 times in total in the conveying direction X by the above described steps.

As described above, in the second known method in which cutting is performed first and printing is performed after cutting, the medium 5 is reciprocatively moved 3.5 times in total in the conveying direction X. In Steps S23 and S24, a time for printing each of the crop marks C1 and C2 occurs, and in Step S25, a time for waiting for drying ink forming the crop marks C1 and C2 occurs. Furthermore, in Steps S27 and S28, a time for correcting the cutting position occurs, and in Steps S31 and S32, a time for correcting the print position occurs.

In the second known method, as compared to the first known method, a time for waiting for drying ink forming the image 200 does not occur, but the time for waiting for drying ink forming the crop marks C1 and C2 still occurs. The number of times the medium 5 is reciprocatively moved is increased to a larger number than that of the first known method. The number of times position correction is performed is also increased.

The number of times the medium 5 is reciprocatively moved in the second known method can be reduced to a number that is the same as that in the first known method simply by omitting printing of the crop marks C1 and C2. However, when the printing of the crop marks C1 and C2 is simply omitted, the positional relation between the cut line 210 for cutting and the image 200 is likely to be shifted. Especially in the printer with a cutting head using the medium 5 wound into a roll shape, position accuracy in cutting is highly likely to be impaired by resistance when the medium 5 is pulled out from the roll 5a. As a result, the positional relation between the cut line 210 and the image 200 is highly likely to be shifted.

Steps of Printing and Cutting According to This Preferred Embodiment

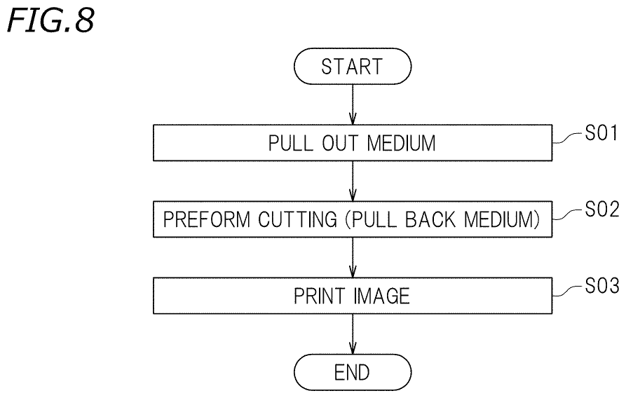

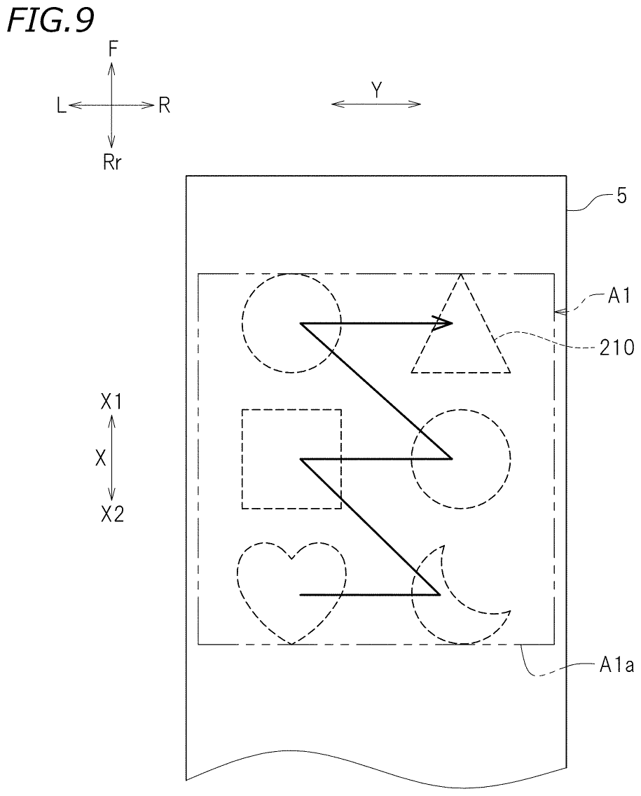

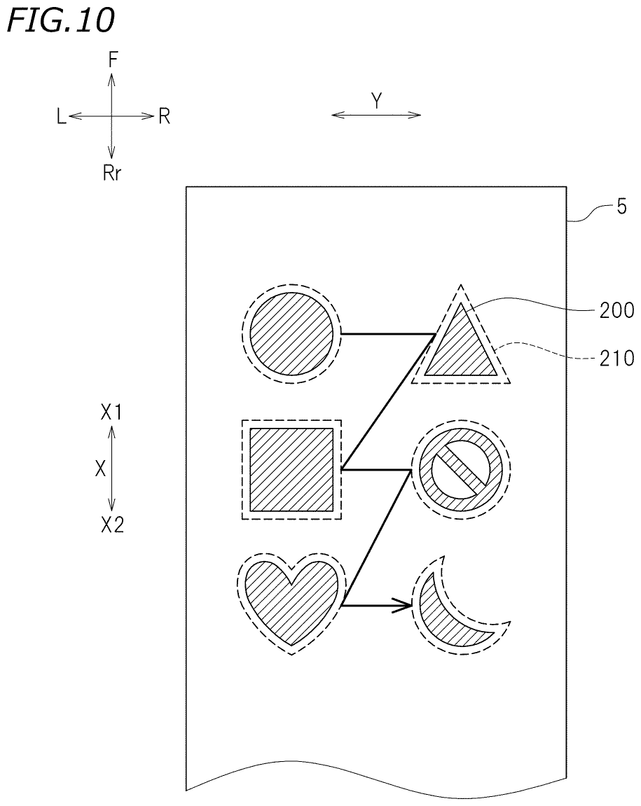

In view of the above described problems about productivity and positioning in printing and cutting, the printer 10 according to this preferred embodiment of the present invention is operative such that a shift between positions of the image 200 and the cut line 210 is reduced or prevented while increasing productivity. FIG. 8 is a flowchart illustrating steps of printing and cutting according to this preferred embodiment. FIG. 9 is a plan view illustrating the medium 5 on which cutting has been performed by the printer 10 according to this preferred embodiment. FIG. 10 is a plan view illustrating the medium 5 on which cutting and printing have been performed by the printer 10 according to this preferred embodiment. As illustrated in FIG. 8, in this preferred embodiment, Steps S01 to S03 are executed.

In Step S01, the medium 5 is pulled out in the first conveying direction X1 (forward). In Step S01, the medium 5 is pulled out from the roll 5a until a cutting area A1 illustrated in FIG. 9 is moved to be located farther in the first conveying direction X1 than the cutting head 70. The cutting area A1 is an area on the medium 5 in which the cutting head 70 performs cutting. The cutting area A1 is determined based on the cutting data. Accordingly, the printer 10 conveys the medium 5 in the first conveying direction X1 until all of cut lines 210 on the cutting data are moved to be located farther in the first conveying direction X1 than the cutting head 70. More specifically, the printer 10 conveys the medium 5 in the first conveying direction X1 until a rear end (an end in the second conveying direction X2) A1a of the cutting area A1 reaches under the cutting head 70. However, the medium 5 may be slightly excessively moved. In that case, an area slightly behind the rear end A1a of the cutting area A1 is located under the cutting head 70. The medium 5 that has adhered to the roll 5a is pulled out from the roll 5a by Step S01. The cutting area A1 is moved to a position farther forward than the cutting head 70.

In subsequent Step S02, cutting is performed while moving the medium 5 in the second conveying direction X2 (rearward). In a case illustrated in FIG. 9, cutting is performed in an order indicated by an arrow illustrated in FIG. 9. When cutting is terminated, the medium 5 has been already moved back to the print start position. As understood from FIG. 9, in this preferred embodiment, “performing cutting while conveying the medium 5 in the second conveying direction X2” includes a case in which, even when the medium 5 is temporarily moved in the first conveying direction X1 that is an opposite direction to the second conveying direction X2, the medium 5 is finally moved in the second conveying direction X2. The medium 5 is reciprocatively moved once in the conveying direction X by the steps described so far.

Cutting of Step S02 is performed while moving back the medium 5 that has been pulled out from the roll 5a once toward the roll 5a. Accordingly, resistance that blocks movement of the medium 5 due to adhesion of the roll 5a and the medium 5 is not generated. Therefore, the cut line 210 is able to be processed in a desired position. For example, when, instead of Steps S01 and S02, cutting is performed while moving the medium 5 the first conveying direction X1 first without performing any other steps therebefore, the medium 5 cannot be conveyed by a desired distance because of resistance resulting from peeling off the medium 5 from the roll 5a, and the position of the cut line 210 is highly likely to be shifted from a target position.

Note that, in Steps S01 and S02, the heater 12 is stopped. The heater 12 is used for drying ink and is not needed in cutting. The heater 12 is stopped in order not to cause the medium 5 to be expanded and contracted by heat herein. However, the heater 12 may be operated also during Steps S01 and S02.

In Step S03, printing of the image 200 is performed while moving the medium 5 in the first conveying direction X1 (forward). In Step S03, printing of the image 200 is performed in an order indicated by an arrow illustrated in FIG. 10. In Step S03, the heater 12 heats the platen 11. Thus, the medium 5 is heated, and drying ink is promoted. The image 200 and the cut line 210 illustrated in FIG. 10 are formed by Step S03. In this preferred embodiment, upon termination of Step S03, all steps of printing and cutting are terminated. The medium 5 is reciprocatively moved 1.5 times in the conveying direction X by Steps S01 to S03.

As described above, the printer 10 according to this preferred embodiment determines the cutting area A1, based on the cutting data, and performs Step S01 of pulling out the medium 5 from the roll 5a until the cutting area A1 is located farther in the first conveying direction X1 than the cutting head 70. Furthermore, after Step S01, Step S02 of cutting is performed while moving the medium 5 in the second conveying direction X2. Furthermore, after Step S02, Step S03 of printing while moving the medium 5 in the first conveying direction X1 is performed. According to the above described printer 10, the number of times the medium 5 is reciprocatively moved is 1.5 times. According to the above described printer 10, the number of times the medium 5 is reciprocatively moved can be reduced as compared to the first and second known methods. Therefore, productivity is further increased as compared to the first and second known methods. As compared to the first known method, productivity is increased in a point that a step of waiting for drying ink is not needed.

According to the above described printer 10, cutting is performed while moving back the medium 5 that has been pulled out from the roll 5a once toward the roll 5a, and therefore, resistance when the medium 5 is pulled out from the roll 5a is not added during cutting. Therefore, a shift of the cutting position is able to be reduced or prevented.

Furthermore, in this preferred embodiment, a positional relation between the cut line 210 and the image 200 is not influenced by expansion and contraction of the medium 5 caused by impact of ink thereon. As described above, a cause of a shift of the positional relation between the cut line 210 and the image 200 is expansion and contraction of the medium 5 caused by impact of the ink thereon. In the printer 10 according to this preferred embodiment, cutting is performed before printing. Therefore, expansion and contraction of the medium 5 caused by impact of the ink is not related to the position accuracy in cutting. As a result, the printer 10 according to this preferred embodiment is able to reduce or prevent a shift of the positional relation between the image 200 and the cut line 210.

In this preferred embodiment, the heating controller 105 is set to stop the heater 12 during cutting and operate the heater 12 during printing. Therefore, the heater 12 does not heat the medium 5 during cutting, and expansion and contraction of the medium 5 by heat of the heater 12 are less likely to occur. Accordingly, a shift of the cutting position is able to be reduced or prevented also by the above described configuration.

Note that a cause of the shift of the positional relation between the image 200 and the cut line 210 is a slip of the medium 5 during conveyance of the medium 5. In this preferred embodiment, a conveying distance of the medium 5 is small, and therefore, an accumulated slip amount of the medium 5 is small. Accordingly, position shifts in cutting and printing are small. Position accuracy in cutting and printing is able to be increased by reducing the conveying distance of the medium 5. The present inventor actually performed printing and cutting by the printer 10 according to this preferred embodiment and confirmed that there is no problem in the positional relation between the cut line and the image.

Furthermore, the first cutting controller 103a according to this preferred embodiment is set to perform, after the medium 5 has been pulled out from the roll 5a in Step S01, cutting without correcting the cutting position. As illustrated in FIG. 9, in this preferred embodiment, the crop marks C1 and C2 are not printed, and correction of the cutting position using the crop marks C1 and C2 is not performed. According to the above described configuration, a time required for correcting the cutting position is able to be omitted, and productivity is able to be further increased. A time for printing the crop marks C1 and C2 is able to be also omitted.

Similarly, the first print controller 104a according to this preferred embodiment is set to perform, after cutting of Step S02, printing without correcting the print position. In this preferred embodiment, correction of the print position using the crop marks C1 and C2 is not performed before printing. According to the above described configuration, a time required for correcting the print position is able to be omitted, and productivity is able to be further increased.

Preferred embodiments of the present invention have been described above. However, the above-described preferred embodiments are merely examples and the present invention may be implemented in various other forms.

For example, the above described printer with a cutting head according to a preferred embodiment of the present invention does not perform cutting after correcting the cutting position, but it may do so. For example, the printer with a cutting head may be operative such that a mode in which cutting is performed without correcting the cutting position (the above described preferred embodiment) and a mode in which cutting is performed after correcting the cutting position can be selected. Similarly, the printer with a cutting head may be operative such that a mode in which printing is performed without correcting the print position (the above described preferred embodiment) and a mode in which printing is performed after correcting the print position can be selected. In that case, steps of printing crop marks and performing alignment, based on the crop marks, are added. Even in that case, cutting is performed while moving back the medium in the second conveying direction, and therefore, the medium is moved less than in the second known method accordingly. Therefore, higher productivity than that of the second known method can be realized.

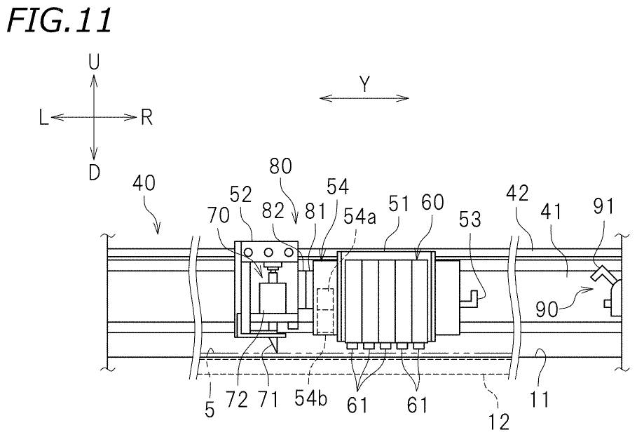

In the above described preferred embodiment, the ink is thermosetting ink, and the printer 10 includes the heater 12 that dries the ink. However, the ink is not limited to the thermosetting ink, and may be, for example, photo curable ink. FIG. 11 is a front view illustrating a configuration of the first carriage 51 in a case in which photo curable ink is used. As illustrated in FIG. 11, the printer with a cutting head according to this preferred embodiment includes a light irradiator 54 that irradiates a medium with light that cures ink. The light irradiator 54 radiates ultraviolet rays herein. The ink is an ultraviolet curing ink. The light irradiator 54 includes an ultraviolet lamp 54a inside. The ultraviolet lamp 54a is a light source that emits an ultraviolet ray. The light irradiator 54 includes an irradiation port 54b in a lower surface. The irradiation port 54b is provided by fitting a cover that transmits ultraviolet rays into an opening in the lower surface of the light irradiator 54. The light irradiator 54 is provided in a left side of the print head 60 in the first carriage 51. The light irradiator 54 is moved with the print head 60 as one unit and irradiates an area on the medium to which the print head 60 has ejected ink with ultraviolet rays. According to the above described printer with a cutting head, the medium is not heated, and therefore, temperature of the medium during cutting and temperature of the medium during printing is less likely to differ from each other. Therefore, accuracy of alignment of the cutting position with the print position is able to be increased.

In addition, the preferred embodiments described herein do not limit the present invention unless specifically state otherwise.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms and should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the invention. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer comprising:
a holder to rotatably hold a roll onto which a medium is wound;
a conveyer to convey the medium in a first conveying direction in which the medium is pulled out from the roll and in a second conveying direction in which the medium that has been pulled out is moved back toward the roll;
a cutting head;
a cutting head mover to move the cutting head such that the cutting head crosses a conveying path of the medium;
a print head to perform printing on the medium on the conveying path; and
a controller; wherein
the controller is configured or programmed to include:
a data storage to save cutting data and print data;
a first processor to determine, based on the cutting data saved in the data storage, a cutting area on the medium in which the cutting head performs cutting;
a second processor to control the conveyer to pull out the medium from the roll until at least the cutting area is moved along the conveying path of the medium to be located farther in the first conveying direction than the cutting head;
a cutting controller to control, after the medium has been pulled out by the second processor, the cutting head mover, the cutting head, and the conveyer to perform cutting while conveying the medium in the second conveying direction; and
a print controller to control, after cutting has been performed on the medium by the cutting controller, the print head and the conveyer to perform printing while conveying the medium in the first conveying direction.

2. The printer according to claim 1, wherein the cutting controller includes a first cutting controller set to perform, after the medium has been pulled out from the roll by the second processor, cutting without correcting a cutting position.

3. The printer according to claim 1, wherein the print controller includes a first print controller to perform, after cutting has been performed on the medium by the cutting controller, printing without correcting a print position.

4. The printer according to claim 1, further comprising:
a heater that heats the medium; wherein
the print head ejects thermosetting ink onto the medium; and
the controller includes a heating controller set to stop the heater during cutting and operate the heater at least one of during printing and after printing.

5. The printer according to claim 1, further comprising:
a light irradiator; wherein
the print head ejects photo curable ink onto the medium; and
the light irradiator irradiates the medium with light that cures the ink.
